(19) United States
(12) Patent Application Publication
(10) Pub. No.: US 2022/0064381 A1
(43) Pub. Date: Mar. 3, 2022

(54) SILICONE POTTING COMPOSITION AND USES THEREOF

(71) Applicant: Illinois Tool Works Inc., Glenview, IL (US)

(72) Inventor: John Kenneweg, Glenview, IL (US)

(73) Assignee: Illinois Tool Works Inc., Glenview, IL (US)

(21) Appl. No.: 17/465,024

(22) Filed: Sep. 2, 2021

Related U.S. Application Data
(60) Provisional application No. 63/073,974, filed on Sep. 3, 2020.

(51) Int. Cl. C08G 77/12; C08G 77/08; C08K 3/38; C08K 9/06; C08K 7/18; B29C 39/00

(52) U.S. Cl. CPC C08G 77/12; C08G 77/08; C08K 3/38; C08K 9/06; C08K 7/18; B29K 2283/00; C08K 2003/385; C08K 2201/011; C08K 2201/005; C08K 2201/016; B29C 39/006

(57) ABSTRACT

A two-part formulation for a potting composition is provided that includes a part A including silicone polymer precursors, boron nitride present in an amount of from 20 to 60 total weight percent as particulate or 1 to 8 total weight percent as boron nitride nanotubes, a platinum or rhenium addition catalyst. A part B includes a hydride functional siloxane operative to cure the silicone polymer precursors and devoid of said platinum or rhenium addition catalyst. When cured in the presence of the voltage producing substrate, a potting is formed that has high thermal conductivity and low electrical conductivity.

### RELATED APPLICATIONS

This application is a non-provisional application that claims priority benefit of U.S. Provisional Application Ser. No. 63/073,974 filed 3 Sep. 2021; the contents of which are hereby incorporated by reference.

### FIELD OF THE INVENTION

The present invention in general relates to potting compounds and in particular to a boron nitride filled silicone compound with high thermal conductivity and low electrical conductivity compared to conventional compositions.

### BACKGROUND OF THE INVENTION

Potting and encapsulation compounds are generally formed as epoxy, silicone, or polyurethane curable systems. Potting compounds are used in low, medium, and high voltage applications and feature outstanding electrical insulation properties, superior adhesive strength, thermal stability and chemical resistance. Potting compounds provide reliable long term performance for microelectronic, electronic, electrical devices, components including: power supplies, switches, ignition coils, electronic modules, motors, connectors, sensors, cable harness assemblies, capacitors, transformers, and rectifiers.

Potting compounds are generally designed to be impervious to hostile environmental conditions, and offer advantages such as enhanced thermal management properties, exceptionally low coefficients of thermal expansion, crack resistance, protection against corrosion, elevated temperature and cryogenic serviceability, and the ability to withstand rigorous thermal cycling and shock, as well as vibration. Specific grades of potting and encapsulation materials are used for tamper proofing, infiltrating densely packed components, sealing tightly wound coils, underfills, for high voltage indoor/outdoor applications where arcing/tracking are a concern, and high vacuum situations

In a typical potting process, an electronic assembly is placed inside a mold (i.e., the “pot”) which is then filled with an insulating liquid compound that hardens, permanently protecting the assembly. The mold may be part of the finished article and may provide shielding or heat dissipating functions in addition to acting as a mold. When the mold is removed the potted assembly is described as cast. Alternatively, a circuit board assembly may be coated with a layer of transparent conformal coating rather than potting. Conformal coating provides most of the benefits of potting, and is lighter and easier to inspect, test, and repair. Conformal coatings can be applied as liquid or condensed from a vapor phase. When potting a circuit board that uses surface-mount technology, low glass transition temperature (Tg) potting compounds such as polyurethane or silicone may be used, because high Tg potting compounds may break solder bonds through solder fatigue because by hardening at a higher temperature the coating then shrinks as a rigid solid over a larger part of the temperature range thus developing greater force.

Potting is also applied around a transformer, the components are cast, potted, or encapsulated, in two-component, epoxy, urethane, silicone, or other reactive resins, to allow for usage in hazardous areas or underwater. Often resins are filled with abrasive particulate to harden the potting surface. The application of such potting resins under vacuum offers the advantage that components with narrow gaps, small holes or angular shapes can be cast quickly. Typical applications involving vacuum casting and potting & encapsulating under vacuum are ignition coils, transformers, computer chips, sensors, and electrical devices.

While there have been many advances in potting and encapsulation materials there continues to be a need for improved potting and encapsulation materials, especially in the context electrical equipment that requires high thermal conductivity and low electrical conductivity to operate more efficiently and as a result often extending the longevity of the equipment. For example, with respect to high-power voltage supplies, there is a continually increased demand for more power with a concurrent reduction in size of high-power voltage supplies. These power supply demands contribute to problems with overheating. Inadequate heat dissipation contributes to premature failure of use power supplies. However, current solutions to improved heat dissipation also increase electrical conductivity which is a problem of its own with regards to potting and encapsulation materials.

Thus, there exists a need for improved potting and encapsulation materials that provide high thermal conductivity and maintain low electrical conductivity.

### SUMMARY OF THE INVENTION

A two-part formulation for a potting composition is provided that includes a part A including silicone polymer precursors, boron nitride present in an amount of from 20 to 60 total weight percent as particulate or 1 to 8 total weight percent as boron nitride nanotubes, a platinum or rhenium addition catalyst. A part B includes a hydride functional siloxane operative to cure the silicone polymer precursors and devoid of said platinum or rhenium addition catalyst. When cured in a voltage producing substrate, a potting is formed that has high thermal conductivity and low electrical conductivity.

### DETAILED DESCRIPTION OF THE PREFERRED EMBODIMENTS

The present invention has utility as a potting composition. The present invention provides a potting and encapsulation material that is well suited for high power applications and offers high thermal conductivity while maintaining a low electrical conductivity that insulates and acts as a dielectric between conductors and conductive surfaces, compared to conventional potting materials through resort to an addition cured two part silicone with high loadings of boron nitride (BN) particulate. The addition of BN increases the thermal conductivity of the inventive potting composition while maintaining a low level of electrical conductivity thereby providing a high degree of electrical insulation as a result high voltage electrical equipment operates more efficiently with an inventive potting composition.

Numerical ranges cited herein are intended to recite not only the end values of such ranges but the individual values encompassed within the range and varying in single units of the last significant figure. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

As used herein, “high voltage” is defined as 1000 Volts or more for alternating current, and at least 1500 Volts for direct current.

As used herein, “cure moderator” is a compound added to delay cure with lower molecular weight components preferentially crosslinking prior to the higher molecular weight components thereby slowing the increase in molecular weight to create a 2 to 30 minute open time prior to a rapid increase in cure.

As used herein, “working time” is the time between the beginning of the setting reaction, when the ethylenically unsaturated-containing organopolysiloxane, the organohydrogenpolysiloxane, and the platinum catalyst are mixed and the time the setting reaction has proceeded to the point at which it is no longer practical to perform further physical work upon the system, e.g., reform it, for its intended purpose. When the reaction has proceeded to this later point the material is said to have reached its “gel point.” The working time in some embodiments provides enough time to mix and place the composition into a desired form.

As used herein, “setting time” is the time sufficient curing has occurred to allow removal of the silicone composition without causing permanent deformation of the silicone composition. The setting time may be approximated, for example, by measuring the torque of the reacting composition on an oscillatory rheometer with a maxima torque value corresponding to full set.

An inventive potting composition is stored as a two part resin system that is combined to initiate cure. Ethylenically unsaturated terminated polymers are employed herein in an addition cure system. The bond forming chemistry according to the present invention is the platinum catalyzed hydrosilylation reaction which proceeds according to the following generic reaction (1):

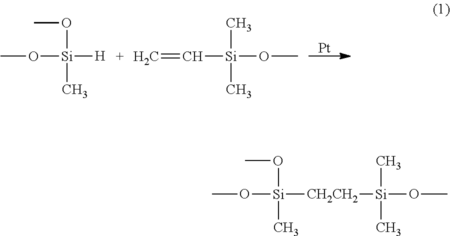

The resulting silicone is well suited for high voltage applications of the present invention.

An important feature of the inventive cure system is that no byproducts are formed, allowing fabrication with good dimensional stability. Cures below 50° C., defined herein as Room Temperature Vulcanizing (RTV), cures between 50° and 130° C., defined herein as Low Temperature Vulcanizing (LTV), and cures above 130° C., defined herein as High Temperature Vulcanizing (HTV), are all readily achieved by addition cure in the present invention. The rheology of the inventive composition is also amenable to be varied widely, ranging from dip-cures to liquid injection molding (LIM) and conventional heat-cure rubber (HCR) processing. Ethylenically unsaturated-terminated polydimethylsiloxanes with viscosities greater than 200 centiStokes (cSt) generally have less than 2% volatiles and form the base precursors for inventive compositions. More typically, base precursors range from 1000 to 60,000 cSt, as measured at 20° C.

The crosslinking polymer is generally a hydride functional siloxane. Hydride functional siloxanes operative herein illustratively include methylhydrosiloxanedimethylsiloxane copolymer with 15-50 mole % methylhydrosiloxane, SiH terminated polydimethylsiloxanes, and combinations thereof. A catalyst operative herein a complex of platinum in alcohol, xylene, divinylsiloxanes or cyclic vinylsiloxanes.

Part A part contains the ethylenically unsaturated-containing silicone and the platinum catalyst and the part B part contains the hydride functional siloxane.

The reinforcing filler is BN particulate that in some inventive embodiments is surface treated.

The hydrosilylation of ethylenically unsaturated functional siloxanes by hydride functional siloxanes is the basis of addition cure chemistry used in 2-part RTVs and LTVs. The most widely used materials for these applications are methylhydrosiloxane-dimethylsiloxane copolymers which have more readily controlled reactivity than the homopolymers and result in tougher polymers with lower cross-link density.

In principle, the reaction of hydride functional siloxanes with ethylenically unsaturated functional siloxanes takes place at 1:1 stoichiometry. In some inventive embodiments, the ratio of hydride to ethylenic unsaturation ranges from 1.2:1 to 4.8:1.

Addition cure silicones of the present invention offer exceptional heat resistance and work better in high temperatures than condensation cure silicones. Another important attribute of the inventive addition cure silicones is that they have virtually no shrinkage and no byproducts, attributes important in conformal coatings.

While the present invention is detailed herein with respect to a 1:1 by weight ratio mixture of Part A: Part B, it is appreciated that other mix ratios are readily compounded ranging from 20-1:1 Part A: Part B without departing from the spirit of the present invention.

An inventive formulation in certain embodiments also includes nonreactive silicone oils, pigments, cure moderators, and combinations thereof. Such additives are limited only by the requirement of compatibility with the other components of an inventive formulation. Such additives are provided to balance or otherwise modify at least one property of an inventive formulation as to handling, storage, cure rate, or adhesive properties.

in the practice of the present invention, the curable silicone composition can be a multiple-component composition cured by the presence of crosslinking agents and catalysts. Most preferred are two-part addition cure compositions of the room temperature vulcanizing (“RTV”) variety. The composition contains a curable silicone prepolymer such as a polysiloxane having one or more ethylenically unsaturated functional groups that enable the piepolymer to be polymerized or cured to a state of higher molecular weight. Suitable silicone prepolymers operative herein illustratively include, silicone, fluids terminated with ethylenically unsaturated functional groups and having viscosities of from 1(R) to 5000 Centipoise and have a generic formula:

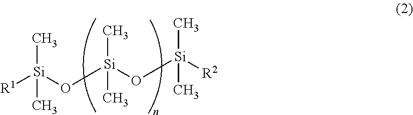

where R¹ and R² are each independently unsaturated aliphatic groups having 1 to 20 carbon atoms and includes alkenyls such as vinyl, allyl, 1-hexenyl; and cycloalkenyis, such as cyclohexenyl. It is appreciated that beyond the linear structure of formula (2), branches siloxanes are also operative herein. It is also appreciated that methyl groups of formula (2) are each independently substituted with other monovalent hydrocarbyl and halogenated monovalent hydrocarbyl groups such as C₂-C₆ alkyls, phenyl, cyanoethyl, triftuororopropyl, and combinations thereof. Additionally, one or more of the methyl groups can be a functional group R¹ or R² resulting in a trifunaional or pollyfunctional siloxane. Furthermore, it is appreciated that while the groups R¹ and R² are depicted as terminal in formula (2), such groups can also be present in pendent positions. The average value of n is between 10 and 6000, while in other embodiments, the average value of n is between 50 and 2000. It is appreciated that mixtures of more than one molecular weight, variable n, are utilized to utilized adjust properties such as part A viscosity and cure rate.

The curable silicone prepolymer of part A is reacted with a hydride functional siloxane of part B to form the potting composition silicone matrix in which BN particulate is embedded. It is appreciated that curable silicone prepolymer can also be present in the part B as well with the proviso that no addition catalyst is present in part B that would initial cure therebetween. The hydride functional siloxane functions as a crosslinker and can be present as a monomer, oligomer, polymer, or combination thereof. Exemplary crosslinkers according to the present invention are detailed in U.S. Pat. No. 3,410,886, The crosslinker containing the silicon-hydrogen bond should contain at least two silicon-hydrogen bonds per crosslinker molecule with the understanding that tri-or poly functional crosslinker molecules impart a higher degree of cross linkages between otherwise linear silicone chains.

Hydride functional siloxane operative in the present invention include:

Silanes having the empirical formula (3):

(H)ₐ(R³)_{b}Si_{c} (3)

wherein R³ in each occurrence is independently a monovalent C₁-C₁₈ hydrocarbyl group, a monovalent C₀-C₁₀ hydroalkoxyl groups and a halogenated monovalent C₁-C₂₅ hydrocarbyl groups, c represents an integer having a value from 1 to 10,000, a represents an integer having a value at least 2 and less than or equal to c when c is greater than 1, and the sum of a and b equals the sum of 2 and twice c;

silanes having the empirical formula (4):

H_{d}R³ₑ(SiO)_{f} (4)

where R³ in each occurrence is independently as defined above with respect to (3), f represents an integer having a value from 3 to 25, d represents an integer having a value at least 2 and less than or equal to f, and the sum of d and e equals twice f; and

silanes having the empirical formula (5):

(H)_{g}(R³)ₕSiⱼO₍ⱼ₋₁₎ (5)

where R³ in each occurrence is independently as defined above with respect to (3), j represents an integer having a value from 2 to 10,000, g represents an integer having a value at least 2 and less than or equal to j, and the sum of g and h equals the sum of 2 and twice j.

Specific groups R operative herein illustratively include alkyls such as methyl, ethyl, propyl, octyl, and octadecyl; cycloalkyls having 5 to 7 ring carbon atoms such as cyclohexyl and cycloheptyl; aryl groups having 6 to 18 carbon atoms such as phenyl, naphthyl, tolyl, xylyl; alkoxyl groups having 0 to 18 carbon atoms such hydroxyl (no carbon atom intermediate between silicon atom and hydrodroxyl), methoxyl, ethoxyl, propoxyl; and combinations of alkyl and aryl groups such as aralkyl groups of benzyl and phenylethyl; halo substituted versions of any of the aforementioned such as chloromethyl, chlorophenyl, and dibromophenyl.

Additional catalysts operative in the present invention are largely limited only by solubility or dispersibility in either part A or part B of an inventive formulation from which the potting composition is derived upon mixing. Platinum catalysts operative herein are detailed in L. N. Lewis et al. “Platinum Catalysts Used in the Silicones Industry Their Synthesis and Activity in Hydrosilylation,” Platinum Metals Rev., 1997, 41, (2), 66. Such catalysts include Karstedt platinum catalysts and platinum nanocrystals. Organometallic ruthenium catalysts are also operative herein as detailed in U.S. Pat. No. 7,803,893B2.

In some inventive embodiments, a. cure moderator is also present. Moderators operative herein illustratively include 3-divinyltetramethyldisiloxane, tetramethylcyclotetrasiloxane, and combinations thereof.

BN used in embodiments of the inventive potting composition is typically present from 20 to 60 total weight percent. Factors relevant to the amount of BN particulate present include particle size, particle aspect ratio, particle surface modification, required amount of thermal conductivity and electrical insulation. It has been observed that a percolation threshold exists with BN particulate loads of a given size and shape present above the threshold providing exceptional thermal conductivity and electrical insulation to the resulting potting composition. Without intending to be bound to a particular theory, efficient inter-particle transmission of heat occurs at loadings above the percolation threshold. Typical sizes of BN particles is between 5 and 1000 microns. In still other inventive embodiments, BN particles are between 80 and 350 microns. BN particles operative herein typically having an aspect ratio between two normal maximal linear dimensions of between 1 and 1.6. In still other embodiments, BN nanotubes are also operative herein and have wall thicknesses of 1 to 5 walls with a length of 100 to 200 microns. It is appreciated that BN nanotubes are effective at loadings of from 1 to 8 total weight percent to achieve percolation threshold levels.

It is appreciated that BN has a variety of crystal structures including hexagonal, cubic and wurtzite that can co-exist with one another as well as amorphous and render BN anisotropic in properties of heat dissipation and electrical insulation. The hexagonal phase, being analogous to graphite has dramatically different properties in plane, as compared to orthogonal to the plane of atoms. This difference is routine attributed to covalent in plane bonding, as compared to van der Waals bonding between sheets of atoms. By forming and dispersing BN as particulate in the present invention at high loadings, this anisotropy in BN properties is averaged out along a given direction.

In some inventive embodiments, the BN particles are chemically bonded with a surface treating agent. The surface treatment promotes wetting of the BN particles by the liquid components of the formulation. It is also appreciated that some treatments involve coupling agents with reactive groups that extend from the BN particle surface and are able to react during addition cure to covalently bond BN particles to the silicone matrix. Surface treating agents for BN illustratively include polytetrafluoroethylene, 1,1,1,3,3,3 -hexamethyldisilazane, tetraethoxysilane, allyltrimethoxysilane, 3-aminopropyltriethoxysilane, 3-aminopropyltriethoxysilane, 3-gylcidoxypropyltrimethoxysilane, 3-glycidoxypropyltriethoxysilane, (3-glycidoxypropyl)bis(trimethylsiloxy)methylsilane, (3-glycidoxypropyl)dimethylethoxysilane, (3-glycidoxypropyl)methyldiethoxysilane, (3-glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, methacryloxypropylmethyldimethoxysilane, methacryloxypropyltrimethoxysilane; methacryloxypropyltriethoxysilane, 3-methacryloxypropyldimethylchlorosilane, methacryloxypropylmethyldichlorosilane, methacryloxypropyltrichlorosilane, 3-isocyanotopropyldimethylchlorosilane, 3-isocyanatopropyltriethoxysilane, and methacryloxypropyltriethoxysilane, cyclic azasilanes, and combinations thereof. Surface treating agents are typically present at from 1 to 3 weight percent of the BN particulate and if present are included in the weight percentage of BN particulate.

Embodiments of the inventive potting composition are formulated to have the following general range of performance parameters. An initial viscosity in the 3,000 to 20,000 cps and some specific embodiments from 8,000 to 14,000 cps. Viscosity build in some embodiments upon cure initiation achieve a viscosity increase of at least 2 in a time of from 1 to 4 hours and a shore hardness of A 10 in from 8 to 14 hours. In some inventive embodiments, a nominal initial viscosity of 10,000 cps attains a viscosity of 25000 cps in 2 hours and overnight to shore A 10. A dielectric constant of between 3.0 and 4.0 is obtained upon cure. A thermal conductivity of 0.8 to 1.2 W/mK or even higher is achieved. The resultant compound is a soft material having a Young's modulus of less than 12 kPa. The dielectric strength is typically between 250 and 560 volts/Mil.

Table 1 provides weight percentages for the ingredients of an embodiments of part A as described above.

TABLE 1
Weight percentage of constituent ingredients of part A.

| | Typical | Specific |
|---|---|---|
| | Weight | Weight |
| | (%) | (%) |
| Ingredients | of part A | of part A |
| Curable silicone propolymer | remainder | 35-78 |
| Non-reactive silicone fluid (saturated) | 0-5 | 0-1 |
| BN particulate (versus nanotubes) | 20-60 | remainder |
| Cure moderator | 0-1 | 0-0.1 |
| Pigment | 0-5 | 1-3 |
| Addition cure catalyst (Pt or Rh) | 0.01-0.3 | 0.02-0.08 |
| Various additives, each at: | 0-5 | 0.2-1.5 |

Embodiments of part B include a hydride functional siloxane, BN particulate materials, and optional additives. A hydride functional siloxane present in part B is reactive towards the curable silicone prepolymer of part A through an addition reaction. It is appreciated that the part B, BN particulate is the same type of material as used in part A, or can vary in chemical composition, size, shape, size distribution, or a combination thereof.

The other components in the part B provided in Table 2 have the identities and amounts as detailed above with respect to part A.

TABLE 2
Weight percentage of constituent ingredients of part B.

| | Typical | Specific |
|---|---|---|
| | Weight | Weight |
| | (%) | (%) |
| Ingredients | of part B | of part B |
| Curable silicone prepolymer | 0-60 | 5-50 |
| Hydride functional siloxane | remainder | 2-20 |
| BN particulate (versus nanotubes) | 20-60 | remainder |
| Pigment | 0-5 | 1-3 |
| Various additives, each at: | 0-5 | 0.2-1.5 |

The present invention is further detailed with respect to the following non-limiting examples. These examples are not intended to limit the scope of the invention, including the appended claims

### EXAMPLE 1

A two part formulation for an embodiment of the composition includes as a part A: 17 part A total weight percent 1,000 cps vinyl terminated silicone fluid with 35 part A total weight percent of 200 cps vinyl terminated silicone fluid, 0.03 part A total weight percent of a Karstedt platinum catalyst, and a remainder of 180 micron BN spheres.

A 50 part B total weight percent 1,000 cps vinyl terminated silicone fluid with 9 part B total weight percent of SiH terminated polydimethylsiloxanes with varying SiH content and viscosities, and a remainder of 180 micron BN spheres. Part A has a specific gravity (SPG) of 1.246022, and part B has an SPG of 1.231682. Part A and part B are admixed in a 1:1 weight ratio to achieve a viscosity of 25,000 cps in 2 hours and a shore hardness A 10 after 14 hours.

### EXAMPLE 2

20 part A total weight percent 1,000 cps vinyl terminated silicone fluid with 41 part A total weight percent of 200 cps vinyl terminated silicone fluid, 0.08 part A total weight percent of a Ashby's platinum catalyst, 0.02 part A total weight percent of Andisil MVC and a remainder of 180 micron BN spheres. The part A is admixed with part B for Example to achieve a similar cure.

### EXAMPLE 3

The part A of Example 2 is admixed with part B of 15 part B total weight percent 1,000 cps vinyl terminated silicone fluid, 30 part B total weight percent 200 cps vinyl terminated silicone fluid with 18 part B total weight percent of SiH terminated polydimethylsiloxanes with varying SiH content and viscosities, and a remainder of 180 micron BN spheres. to achieve a similar cure.

### EXAMPLE 4

The process of Example 1 is repeated with 1,1,1,3,3,3-hexamethyldisilazane modified BN in place of the BN particulate to achieve a similar cure.

### EXAMPLE 5

The process of Example 1 is repeated with 5 part A weight percent of BN nanotubes in place of the BN particulate and 5 part B weight percent of BN nanotubes in place of the BN particulate with commensurate increases in 1,000 cps vinyl terminated silicone fluid to achieve a similar result.

### EXAMPLE 6

Embodiments of the potting composition of Examples 1 and 3 are tested for performance parameters with the results summarized in Table 3.

TABLE 3
Performance parameters of inventive potting compositions of Examples 1 and 3 are as follows.

| | | | | Thermal | | | | |
|---|---|---|---|---|---|---|---|---|
| Examples | Specific | Viscosity | Dielectric | Conductivity | Modulus | Dielectric | Dissipation | Hardness |
| # | Gravity | (cps) | Constant | (W/mK) | (psi) | Strength | Factor | (shore A) |
| Ex. 1 | 1.23 | 14,200 | 3.33 | 1.10 | 310 | 401 | 0.0041 | 35 |
| Ex. 3 | 1.20 | 11,500 | 3.24 | 1.00 | 290 | 410 | 0.0038 | 30 |

Patents and publications mention the specification are indicative of the levels of those skilled in the art to which the invention pertains. These patents and publications are incorporated herein by reference to the same extent as if each individual patent or publication is specifically and individually incorporated herein by reference.

The forgoing description is illustrative of particular embodiments of the invention but is not meant to be a limitation upon the practice thereof. The following claims, including all equivalents thereof are intended to define the scope of the invention.

1. A two-part formulation for a potting composition comprising:
a part A comprising:
a plurality of silicone polymer precursors;
part A boron nitride present in an amount of from 20 to 60 total weight percent as particulate or 1 to 8 total weight percent as boron nitride nanotubes; and
a platinum or rhenium addition catalyst; and
a part B comprising:
a hydride functional siloxane operative to cure said plurality of silicone polymer precursors and devoid of said platinum or rhenium addition catalyst.

2. The formulation of claim 1 further comprising part B boron nitride present in an amount of from 20 to 60 total weight percent as particulate or 1 to 8 total weight percent as boron nitride nanotubes in the part B.

3. The formulation of claim 1 further comprising part B silicone polymer precursors.

4. The formulation of claim 1 further comprising a cure moderator in part A.

5. The formulation of claim 1 wherein said part A boron nitride particulate is coupled to a surface treating agent.

6. The formulation of claim 5 wherein said surface treating agent is one of:
polytetrafluoroethylene, 1,1,1,3,3,3-hexamethyldisilazane, tetraethoxysilane, allyltrimethoxysilane, 3-aminopropyltriethoxysilane, 3 aminopropyltriethoxysilane, 3-gylcidoxypropyltrimethoxysilane, 3glycidoxypropyltriethoxysilane, (3-glycidoxypropyl)bis(trimethylsiloxy)methylsilane, (3-glycidoxypropyl)dimethylethoxysilane, (3-glycidoxypropyl)methyldiethoxysilane, (3 glycidoxypropyl)methyldimethoxysilane, methacryloxymethyltriethoxysilane, methacryloxymethyltrimethoxysilane, methacryloxypropyldimethylethoxysilane, methacryloxypropyldimethylmethoxysilane, methacryloxypropylmethyldimethoxysilane, methacryloxypropyltrimethoxysilane;methacryloxypropyltriethoxysilane, 3-methacryloxypropyldimethylchlorosilane, methacryloxypropylmethyldichlorosilane, methacryloxypropyltrichlorosilane, 3 isocyanotopropyldimethylchlorosilane, 3-isocyanatopropyltriethoxysilane, and methacryloxypropyltriethoxysilane, cyclic azasilanes, and combinations thereof. Surface treating agents are typically present at from 1 to 3 weight percent of the BN particulate and if present are included in the weight percentage of BN particulate.

7. The formulation of claim 1 wherein said part A BN particulate is spherical.

8. The formulation of claim 1 wherein said part A BN particulate has an aspect ratio between longest and shortest orthogonal directions of between 1 and 1.6.

9. The formulation of claim 1 wherein said part A BN particulate has an average size of from 5 to 1,000 microns.

10. The formulation of claim 2 wherein said part B BN particulate has a chemical composition and a size of said part A BN particulate.

11. The formulation of claim 1 wherein said platinum or rhenium addition catalyst is an organo-platinum compound.

12. A structure comprising:
a voltage producing substrate; and
a potting formed by the cure of the formulation of claim 1 in simultaneous contact with said substrate.

13. The structure of claim 12 wherein said potting has a dielectric constant of between 3.0 and 4.0.

14. The structure of claim 12 wherein said potting has a thermal conductivity of from 0.8 to 1.2 W/mK.

15. The structure of claim 12 wherein said potting has a Young's modulus of less than 12 kPa.

16. The structure of claim 12 wherein said potting has a dielectric strength is between 250 and 560 volts/Mil.
